(19) United States
(12) Patent Application Publication
(10) Pub. No.: US 2025/0026865 A1
(43) Pub. Date: Jan. 23, 2025

(54) HYALURONIC ACID POWDER

(71) Applicant: Kewpie Corporation, Tokyo (JP)

(72) Inventors: Shunichi FUJIKAWA, Chofu-shi, Tokyo (JP); Mizuka OGURA, Chofu-shi, Tokyo (JP)

(73) Assignee: Kewpie Corporation, Tokyo (JP)

(21) Appl. No.: 18/714,279

(22) PCT Filed: Nov. 30, 2021
(86) PCT No.: PCT/JP2021/043777

§ 371 Date: May 29, 2024

(51) Int. Cl. C08B 37/08; C08J 3/12

(52) U.S. Cl. CPC C08B 37/0072; C08J 3/12

(57) ABSTRACT

Provided is hyaluronic acid powder including: hyaluronic acid particles, in which the hyaluronic acid particles contain hyaluronic acid and/or a salt thereof having an average molecular weight of greater than or equal to 1,500,000, and a content of the hyaluronic acid particles having a particle diameter of less than or equal to 100 micrometers is 0 mass % to 35 mass % based on a total mass of the hyaluronic acid powder.

### TECHNICAL FIELD

The present invention relates to hyaluronic acid powder.

### BACKGROUND ART

Hyaluronic acid is widely distributed in biological tissues such as rooster combs, the umbilical cord, skin, cartilage, the vitreous body, and synovial fluid and is widely used as components of cosmetics, pharmaceuticals, and foods, for example. In particular, hyaluronic acid is being actively applied as an ingredient in medical products and cosmetics due to its high biocompatibility, gel swelling properties, and viscoclasticity.

Various technical means for improving the properties of hyaluronic acid have been reported. For example, Patent Literature 1 discloses a powder which is composed of hyaluronic acid and/or a salt thereof and has an average molecular weight of greater than or equal to 200,000 and an average particle diameter of 50 to 500 micrometers. Patent Literature 2 discloses a method for producing hyaluronic acid powder or a salt thereof, the method including a step of performing a dehydration treatment in which a water-soluble organic solvent is added to an aqueous liquid containing hyaluronic acid and/or a salt thereof to precipitate the hyaluronic acid and/or a salt thereof and separate the precipitate from the mother liquor, a washing treatment in which the precipitate is washed with a 75 to 80 mass % aqueous solution of a water-soluble organic solvent, and a drying treatment in which the washed precipitate is dried, in this order.

### CITATION LIST

### Patent Literature

[Patent Literature 1] Japanese Unexamined Patent Publication No. 2011-84588

[Patent Literature 2] Japanese Unexamined Patent Publication No. 2009-256464

### SUMMARY OF INVENTION

### Technical Problem

Cross-linked hyaluronic acid used for medical use (particularly for cosmetic surgery) is produced by dissolving high molecular weight hyaluronic acid powder, which is a raw material, at a high concentration (for example, greater than or equal to 2 mass %). However, if it is attempted to dissolve high molecular weight hyaluronic acid powder containing hyaluronic acid and/or a salt thereof having an average molecular weight of greater than or equal to 1,500,000 at a high concentration, lumps are casily generated (that is, it takes time to completely dissolve). If a cross-linking reaction is performed while the lumps are present, the viscosity of cross-linked hyaluronic acid obtained does not sufficiently develop.

An object of the present invention is to provide hyaluronic acid powder which contains hyaluronic acid and/or a salt thereof having an average molecular weight of greater than or equal to 1,500,000 and is dissolvable in a short period of time even at a high concentration.

### Solution to Problem

The present invention relates to, for example, each of the following inventions.
[1] Hyaluronic acid powder including: hyaluronic acid particles, in which the hyaluronic acid particles contain hyaluronic acid and/or a salt thereof having an average molecular weight of greater than or equal to 1,500,000, and a content of the hyaluronic acid particles having a particle diameter of less than or equal to 100 micrometers is 0 mass % to 35 mass % based on a total mass of the hyaluronic acid powder.
[2] The hyaluronic acid powder according to [1], in which a relative standard deviation of a particle size distribution is less than or equal to 0.30%.
[3] The hyaluronic acid powder according to [1] or [2], in which the content of the hyaluronic acid particles having a particle diameter of less than or equal to 100 micrometers is 0 mass % to 5 mass % based on a total mass of the hyaluronic acid powder.
[4] The hyaluronic acid powder according to any one of [1] to [3], in which the average molecular weight of the hyaluronic acid and/or a salt thereof is 1,500,000 to 3,900,000.
[5] A method for selecting a raw material hyaluronic acid powder used in a method for producing cross-linked hyaluronic acid and/or a salt thereof, in which the raw material hyaluronic acid powder contains hyaluronic acid particles, the hyaluronic acid particles contain hyaluronic acid and/or a salt thereof having an average molecular weight of greater than or equal to 1,500,000, and a content of the hyaluronic acid particles having a particle diameter of less than or equal to 100 micrometers is 0 mass % to 35 mass % based on a total mass of the hyaluronic acid powder.

### Advantageous Effects of Invention

According to the present invention, it is possible to provide hyaluronic acid powder which contains hyaluronic acid and/or a salt thereof having an average molecular weight of greater than or equal to 1,500,000 and is dissolvable in a short period of time even at a high concentration.

### DESCRIPTION OF EMBODIMENTS

Hereinafter, embodiments of the present invention will be described in detail. However, the present invention is not limited to the following embodiments.

### Characteristics of Present Invention

### Hyaluronic Acid Powder

The present invention provides hyaluronic acid powder including: hyaluronic acid particles, in which the hyaluronic acid particles contain hyaluronic acid and/or a salt thereof having an average molecular weight of greater than or equal to 1,500,000, and a content of the hyaluronic acid particles having a particle diameter of less than or equal to 100 micrometers is 0 mass % to 35 mass % based on a total mass of the hyaluronic acid powder.

### Method for Selecting Raw Material Hyaluronic Acid Powder Used in Method for Producing Cross-Linked Hyaluronic Acid and/or Salt Thereof

The present invention provides a method for selecting a raw material hyaluronic acid powder used in a method for producing cross-linked hyaluronic acid and/or a salt thereof, in which the raw material hyaluronic acid powder contains hyaluronic acid particles, the hyaluronic acid particles contain hyaluronic acid and/or a salt thereof having an average molecular weight of greater than or equal to 1,500,000, and a content of the hyaluronic acid particles having a particle diameter of less than or equal to 100 micrometers is 0 mass % to 35 mass % based on a total mass of the hyaluronic acid powder.

### Hyaluronic Acid Powder

Hyaluronic acid powder is an aggregation of a plurality of hyaluronic acid particles.

### Hyaluronic Acid and/or Salt Thereof

“Hyaluronic acid” refers to a polysaccharide having one or more repeating constitutional units consisting of disaccharides of glucuronic acid and N-acetylglucosamine. A “salt of hyaluronic acid” is not particularly limited but is preferably a salt that is acceptable for food or pharmaceutically acceptable. Examples of salts of hyaluronic acid include sodium salts, potassium salts, calcium salts, zinc salts, magnesium salts, and ammonium salts.

### Average Molecular Weight

Hyaluronic acid particles contain hyaluronic acid and/or a salt thereof having an average molecular weight of greater than or equal to 1,500,000. The average molecular weight of hyaluronic acid and/or a salt thereof may be greater than or equal to 1,500,000, greater than or equal to 1,600,000, greater than or equal to 1,700,000, greater than or equal to 1,800,000, or greater than or equal to 1,900,000. The average molecular weight of hyaluronic acid and/or a salt thereof may be less than or equal to 3,900,000, less than or equal to 3,500,000, less than or equal to 3,000,000, or less than or equal to 2,800,000.

### Method for Measuring Average Molecular Weight

In the present specification, the “average molecular weight” of hyaluronic acid means a viscosity average molecular weight. The average molecular weight is calculated according to the method disclosed in Average Molecular Weight of “Purified Sodium Hyaluronate” of the Japanese Pharmacopoeia (18th revision). Specifically, the amount of hyaluronic acid powder with which the downflowing time for a solution obtained by dissolving the hyaluronic acid powder in 100 mL of a 0.2 mol/L sodium chloride test solution is 2.0 to 2.4 times the downflowing time for the 0.2 mol/L sodium chloride test solution is accurately measured. Hyaluronic acid powder is dissolved in the 0.2 mol/L sodium chloride test solution to accurately prepare 100 mL of a sample solution (1). 16 mL, 12 mL, and 8 mL of the sample solution (1) are accurately measured, and a 0.2 mol/L sodium chloride test solution is added thereto to prepare exactly 20 mL of each of a sample solution (2), a sample solution (3), and a sample solution (4).

Regarding the above-described sample solutions (1) to (4), the time required for a certain volume of liquid to flow down through a capillary tube at 30° C.±0.1° C. using a viscosity determination (viscosity measurement by capillary tube viscometer) as general tests using a Ubbelohde-type viscometer with a downflowing time for a 0.2 mol/L sodium chloride test solution of 200 to 300 seconds is measured to calculate a specific viscosity (Equation (1)) and a reduced viscosity (Equation (2)) at each concentration. A graph is drawn with the reduced viscosity on the vertical axis and the concentration (g/100 mL) of hyaluronic acid in terms of a dried product on the horizontal axis, and an intrinsic viscosity is obtained from the intersection of a straight line connecting each of the points and the vertical axis. The average molecular weight is calculated by Equation (3) from the intrinsic viscosity obtained here.

$$Specific viscosity = \qquad ( 1 )$$

$$\{ ( time required in seconds for sample solution to flow down ) /$$

$$( time required in seconds for 0.2 mol / L$$

$${sodium chloride solution to flow down ) \}}^{- 1}$$

$$Reduced viscosity ( dL / g ) = specific viscosity / \qquad ( 2 )$$

$$( concentration ( g / 100 mL ) of this product in terms of dried product )$$

$$[ Math . 1 ]$$

$$Average molecular weight = {( \frac{[ η ] \times {10}^{5}}{22.8} )}^{\frac{1}{0.816}} \qquad ( 3 )$$

### Content of Hyaluronic Acid Particles Having Particle Diameter of Less Than or Equal to 100 Micrometers

In the hyaluronic acid powder, the content of hyaluronic acid particles having a particle diameter of less than or equal to 100 micrometers is less than or equal to 35 mass % based on the total mass of the hyaluronic acid powder and may be, from the viewpoint of a shorter dissolution time at a high concentration, less than or equal to 30 mass %, less than or equal to 25 mass %, less than or equal to 20 mass %, less than or equal to 15 mass %, less than or equal to 10 mass %, less than or equal to 5 mass %, less than or equal to 3 mass %, less than or equal to 2 mass %, or less than or equal to 1 mass %. In the hyaluronic acid powder, the content of the hyaluronic acid particles having a particle diameter of less than or equal to 100 micrometers is greater than or equal to 0 mass % based on a total mass of the hyaluronic acid powder and may be 0 mass %.

### Content of Hyaluronic Acid Particles Having Particle Diameter of Less Than or Equal to 155 Micrometers

In the hyaluronic acid powder, the content of hyaluronic acid particles having a particle diameter of less than or equal to 155 micrometers based on the total mass of the hyaluronic acid powder may be, from the viewpoint of a shorter dissolution time at a high concentration, less than or equal to 55 mass %, less than or equal to 50 mass %, less than or equal to 45 mass %, less than or equal to 40 mass %, less than or equal to 35 mass %, less than or equal to 30 mass %, less than or equal to 25 mass %, less than or equal to 20 mass %, less than or equal to 15 mass %, less than or equal to 10 mass %, less than or equal to 5 mass %, less than or equal to 3 mass %, less than or equal to 2 mass %, or less than or equal to 1 mass %. In the hyaluronic acid powder, the content of the hyaluronic acid particles having a particle diameter of less than or equal to 155 micrometers is greater than or equal to 0 mass % based on a total mass of the hyaluronic acid powder and may be 0 mass %.

### Content of Hyaluronic Acid Particles Having Particle Diameter of Less Than or Equal to 190 Micrometers

In the hyaluronic acid powder, the content of hyaluronic acid particles having a particle diameter of less than or equal to 190 micrometers based on the total mass of the hyaluronic acid powder may be, from the viewpoint of a shorter dissolution time at a high concentration, less than or equal to 65 mass %, less than or equal to 60 mass %, less than or equal to 55 mass %, less than or equal to 50 mass %, less than or equal to 45 mass %, less than or equal to 40 mass %, less than or equal to 35 mass %, less than or equal to 30 mass %, less than or equal to 25 mass %, less than or equal to 20 mass %, less than or equal to 15 mass %, less than or equal to 10 mass %, less than or equal to 5 mass %, less than or equal to 3 mass %, or less than or equal to 2 mass %. In the hyaluronic acid powder, the content of the hyaluronic acid particles having a particle diameter of less than or equal to 190 micrometers is greater than or equal to 0 mass % based on a total mass of the hyaluronic acid powder and may be greater than or equal to 0.5 mass %.

### Method for Measuring Particle Size Distribution

The contents of hyaluronic acid particles having a particle diameter of less than or equal to 100 micrometers, hyaluronic acid particles having a particle diameter of less than or equal to 155 micrometers, and hyaluronic acid particles having a particle diameter of less than or equal to 190 micrometers are measured using a laser diffraction particle size analyzer. Specific measurement conditions are as described in examples to be described below.

### Relative Standard Deviation of Particle Size Distribution

The relative standard deviation of a particle size distribution may be, from the viewpoint of a shorter dissolution time at a high concentration, less than or equal to 0.30%, less than or equal to 0.28%, less than or equal to 0.25%, less than or equal to 0.20%, less than or equal to 0.15%, less than or equal to 0.10%, or less than or equal to 0.05%. The relative standard deviation of a particle size distribution may be greater than or equal to 0.01%, greater than or equal to 0.02%, or greater than or equal to 0.03%. The relative standard deviation of a particle size distribution means a value calculated by the method shown below.

$$Relative standard deviation ( \% ) = standard deviation / average particle diameter ( micrometer ) \times 100$$

The standard deviation and the average particle diameter are measured by a laser diffraction particle size analyzer.

In the hyaluronic acid powder, the content of hyaluronic acid particles having a particle diameter of greater than or equal to 1 mm based on the total mass of the hyaluronic acid powder may be, from the viewpoint of a shorter dissolution time at a high concentration, less than or equal to 5 mass %, less than or equal to 4 mass %, less than or equal to 3 mass %, less than or equal to 2 mass %, or less than or equal to 1 mass %. In the hyaluronic acid powder, the content of the hyaluronic acid particles having a particle diameter of less than or equal to 1 mm is greater than or equal to 95 mass % based on a total mass of the hyaluronic acid powder and may be greater than or equal to 96 mass %, greater than or equal to 97 mass %, greater than or equal to 98 mass %, or greater than or equal to 99 mass %.

### Origin of Hyaluronic Acid and/or Salt Thereof

Hyaluronic acid and/or a salt thereof may be extracted from natural substances (for example, biological tissue such as rooster combs, umbilical cord, skin, and synovial fluid) of animals or the like, may be obtained by culturing microorganisms, animal cells, or plant cells (for example, through a fermentation method in which bacteria of the genus Streptococcus or the like are used), or may be chemically or enzymatically synthesized.

### Method for Producing Hyaluronic Acid Powder

The method for producing hyaluronic acid powder of the present invention is, for example, a method for producing hyaluronic acid powder containing hyaluronic acid particles containing hyaluronic acid and/or a salt thereof having an average molecular weight of greater than or equal to 1,500,000, the method including adjusting the content of hyaluronic acid particles having a particle diameter of less than or equal to 100 micrometers. A usual method can be used as the method except for adjusting the content of hyaluronic acid particles having a particle diameter of less than or equal to 100 micrometers. For example, the hyaluronic acid powder of the present invention can be produced through a rooster comb extraction method or a microbial fermentation method.

### Rooster Comb Extraction Method

A rooster comb is subjected to a heat treatment. The heat-treated rooster comb is made into a paste and treated with an alkali. Next, a proteolytic enzyme is added to the alkali-treated product of the rooster comb to subject the product to a protease treatment. Activated carbon is added to the obtained protease-treated product to subject the product to deodorization and decolorization treatments, and then, the product is filtered. After dissolving a sodium chloride in the obtained filtrate, ethanol is added thereto, hyaluronic acid is precipitated, and the precipitate is fractionated. Thereafter, aqueous ethanol having a concentration of ethanol of about 80 to 95 volume % is added to the precipitate, and the precipitate is washed in a homogenizer and fractionated. Hyaluronic acid powder can be obtained by repeating the washing with aqueous ethanol about 2 to 10 times and drying the fractionated precipitate.

### Microbial Fermentation Method

Activated carbon is added to a culture liquid of microorganisms (Streptococcus Zooepidemicus) of the genus Streptococcus producing hyaluronic acid to subject the mixture to deodorization and decolorization treatments, and then, the mixture is filtered. After dissolving a sodium chloride in the obtained filtrate, ethanol is added thereto, hyaluronic acid is precipitated, and the precipitate is fractionated. Thereafter, aqueous ethanol having a concentration of ethanol of about 80 to 95 volume % is added to the precipitate, and the precipitate is washed in a homogenizer and fractionated. Hyaluronic acid powder can be obtained by repeating the washing with aqucous ethanol about 2 to 10 times and drying the fractionated precipitate.

### Hyaluronic Acid Solution

A hyaluronic acid solution contains the above-described hyaluronic acid powder and a solvent. In the hyaluronic acid solution, the hyaluronic acid powder is dissolved in the solvent. In a case where there is no insoluble substance confirmed through visual observation, it is determined that the hyaluronic acid powder is dissolved in the solvent.

### Solvent of Hyaluronic Acid Solution

The solvent of the hyaluronic acid solution may be, for example, water. The hyaluronic acid solution may contain inorganic salts together with the solvent. Examples of inorganic salts include sodium hydroxide, sodium chloride, and phosphate.

### Content of Hyaluronic Acid and/or Salt Thereof

The content of hyaluronic acid and a salt thereof (the concentration of hyaluronic acid) in the hyaluronic acid solution may be, based on the total amount of hyaluronic acid solution, greater than or equal to 2 mass %, greater than or equal to 3 mass %, greater than or equal to 4 mass %, greater than or equal to 5 mass %, greater than or equal to 6 mass %, greater than or equal to 7 mass %, greater than or equal to 8 mass %, greater than or equal to 9 mass %, greater than or equal to 10 mass %, greater than or equal to 11 mass %, greater than or equal to 12 mass %, greater than or equal to 13 mass %, or greater than or equal to 14 mass %, and may be less than or equal to 20 mass % or less than or equal to 18 mass %.

### Use of Hyaluronic Acid Solution

The hyaluronic acid solution of the present invention can be used as a raw material for producing cross-linked hyaluronic acid. Cross-linked hyaluronic acid can be used for medical use (particularly for cosmetic surgery use) or the like.

### EXAMPLES

Hereinafter, the present invention will be described in more detail based on examples or the like. However, the present invention is not limited to the following examples. Hereinafter, “%” means “mass %”.

### Production of Hyaluronic Acid Powder

Hyaluronic acid powder of Example 1 having an average molecular weight of 1,900,000 was produced through the above-described microbial fermentation method. The concentration of ethanol used in the production was 80% to 95%, and the number of times a precipitate was washed was 10 times.

Hyaluronic acid of Example 1 was pulverized to obtain hyaluronic acid powder of Comparative Example 5. The hyaluronic acid powder of Example 1 was mixed with the hyaluronic acid powder of Comparative Example 5 according to the mass ratio in Table 1 below to obtain hyaluronic acid powder of Example 2 and hyaluronic acid powder of Comparative Examples 1 to 4.

TABLE 1

| | | Compar- | Compar- | Compar- | Compar- |
|---|---|---|---|---|---|
| | | ative | ative | ative | ative |
| | Example 2 | Example 1 | Example 2 | Example 3 | Example 4 |
| Example 1 | 50% | 40% | 30% | 20% | 10% |
| Comparative | 50% | 60% | 70% | 80% | 90% |
| Example 5 | | | | | |

Measurement results of the proportions of particles of Examples 1 and 2 and Comparative Examples 1 to 4 are shown in Table 2.

### Method for Measuring Particle Size Distribution

The particle size distribution was measured under the following conditions with a laser diffraction particle size analyzer SALD-2200 (Shimadzu Corporation).

### Detection of Diffraction-Scattered Light

Average number of times: 64 times
Number of times of measurement: once
Measurement interval: 2 seconds

### Measured Absorbance Range

Maximum value: 0.2000
Minimum value: 0.0100

### Blank Area/Measurement Area

Blank measurement allowable variation maximum value: 20
Optimal measurement range (maximum): 1500
Optimal measurement range (minimum): 700
Dispersion solvent: ethanol
Dispersant: none
Dispersion method: ultrasonic dispersion
Pump speed: 6.0
Built-in ultrasonic irradiation time: 10 seconds

### Test 1: Relationship between Particle Size Distribution and Dissolution Time

### Method for Confirming Solubility

20 mL of a 1% NaOH aqueous solution was added to a beaker with a capacity of 50 mL, and then, the mixture was stirred with a magnetic stirrer (manufactured by Tokyo Garasu Kikai Co., Ltd., model number F-601, dial scale 4) while adding hyaluronic acid powder of an example or a comparative example. The time until the hyaluronic acid powder was completely dissolved from the time when the hyaluronic acid powder was added thereto was visually measured and recorded as a dissolution time. The content of hyaluronic acid (the concentration of hyaluronic acid) in a hyaluronic acid solution was set to 10 mass % with respect to the total amount of hyaluronic acid solution.

### Results

The measurement results of the dissolution times of hyaluronic acid powder of Examples 1 and 2 and Comparative Examples 1 to 5 are shown.

TABLE 2

| | Proportion (%) of | Proportion (%) of | Proportion (%) of | Particle size distribution | 1% Sodium hydroxide |
|---|---|---|---|---|---|
| | particles of less than | particles of less than | particles of less than | Relative standard | Dissolution time in |
| | or equal to 190 μm | or equal to 155 μm | or equal to 100 μm | deviation (%) | aqueous solution |
| Example 1 | 1 | 0 | 0 | 0.035 | 10 Minutes |
| Example 2 | 55 | 47 | 33 | 0.279 | 20 Minutes |
| Comparative Example 1 | 64 | 56 | 40 | 0.352 | 35 Minutes |
| Comparative Example 2 | 73 | 67 | 54 | 0.565 | 35 Minutes |
| Comparative Example 3 | 71 | 65 | 51 | 0.499 | 40 Minutes |
| Comparative Example 4 | 78 | 73 | 60 | 0.600 | 45 Minutes |
| Comparative Example 5 | 92 | 87 | 71 | 0.472 | 90 Minutes |

It was confirmed that hyaluronic acid powder in which the proportion of hyaluronic acid particles of less than or equal to 100 micrometers is less than or equal to 35 mass % can be dissolved in a short period of time even at a high concentration (hyaluronic acid concentration: 10 mass %).

### Test 2: Effect of Molecular Weight

Hyaluronic acid powder of Example 3 having an average molecular weight of 2,760,000 and the same particle size distribution as that of Example 1 was produced. The dissolution time of the hyaluronic acid powder of Example 3 was measured through the same method as that of Test 1. The results are shown in Table 3.

TABLE 3

| Average | Dissolution time in | |
|---|---|---|
| molecular | 1% aqueous sodium | |
| weight | hydroxide solution | |
| 1,900,000 | 10 | Minutes |
| 2,760,000 | 8 | Minutes |

Even in a case of a high average molecular weight, hyaluronic acid powder in which the proportion of hyaluronic acid particles of less than or equal to 100 micrometers is less than or equal to 35 mass % can be dissolved in a short period of time at a high concentration.

### Test 3: Effect of Concentration of Hyaluronic Acid

The hyaluronic acid powder of Example 1 and Comparative Example 5 was dissolved in a 1% sodium hydroxide solution so as to have concentrations of hyaluronic acid shown in Table 4. The times until the hyaluronic acid powder is dissolved are shown in Table 4.

TABLE 4

| | Molecular | Concentration of Hyaluronic Acid Solution | | | |
|---|---|---|---|---|---|
| | Weight of | 2% | 5% | 10% | 15% |
| | Hyaluronic | Dissolution time in 1% aqueous | | | |
| | Acid | sodium hydroxide solution | | | |
| Example 1 | 1,900,000 | 10 | 6 | 10 | 45 |
| | | Minutes | Minutes | Minutes | Minutes |
| Comparative | 1,930,000 | 60 | 55 | 90 | 90 |
| Example 5 | | Minutes | Minutes | Minutes | Minutes |

Even in a case where the concentration of hyaluronic acid in a hyaluronic acid solution is increased, hyaluronic acid powder in which the proportion of hyaluronic acid particles of less than or equal to 100 micrometers is less than or equal to 35 mass % can be dissolved in a short period of time at a high concentration.

1. Hyaluronic acid powder comprising:
hyaluronic acid particles,
wherein the hyaluronic acid particles comprise hyaluronic acid and/or a salt thereof having an average molecular weight of greater than or equal to 1,500,000,
wherein a content of the hyaluronic acid particles having a particle diameter of less than or equal to 100 μm is 0 mass % to 35 mass % based on a total mass of the hyaluronic acid powder, and
wherein a relative standard deviation of a particle size distribution is less than or equal to 0.30%.

2. The hyaluronic acid powder according to claim 1,
wherein a relative standard deviation of a particle size distribution is less than or equal to 0.30%.

3. The hyaluronic acid powder according to claim 1,
wherein the content of the hyaluronic acid particles having a particle diameter of less than or equal to 100 μm is 0 mass % to 5 mass % based on a total mass of the hyaluronic acid powder.

4. The hyaluronic acid powder according to claim 1,
wherein the average molecular weight of the hyaluronic acid and/or a salt thereof is 1,500,000 to 3,900,000.

5. A method for selecting a raw material hyaluronic acid powder used in a method for producing cross-linked hyaluronic acid and/or a salt thereof,
wherein the raw material hyaluronic acid powder comprises hyaluronic acid particles,
wherein the hyaluronic acid particles comprise hyaluronic acid and/or a salt thereof having an average molecular weight of greater than or equal to 1,500,000, and
wherein a content of the hyaluronic acid particles having a particle diameter of less than or equal to 100 μm is 0 mass % to 35 mass % based on a total mass of the hyaluronic acid powder.

6. The hyaluronic acid powder according to claim 1,
wherein the content of the hyaluronic acid particles having a particle diameter of less than or equal to 100 micrometers is 0 mass % to 30 mass % based on a total mass of the hyaluronic acid powder.

7. The hyaluronic acid powder according to claim 1,
wherein the average molecular weight of the hyaluronic acid and/or a salt thereof is greater than or equal to 1,600,000.

8. The hyaluronic acid powder according to claim 1,
wherein the average molecular weight of the hyaluronic acid and/or a salt thereof is greater than or equal to 1,700,000.

9. The hyaluronic acid powder according to claim 1,
wherein the average molecular weight of the hyaluronic acid and/or a salt thereof is greater than or equal to 1,800,000.

10. The hyaluronic acid powder according to claim 1,
wherein the average molecular weight of the hyaluronic acid and/or a salt thereof is greater than or equal to 1,900,000.

11. The hyaluronic acid powder according to claim 1,
wherein the average molecular weight of the hyaluronic acid and/or a salt thereof is greater than or equal to 2,760,000.

12. The hyaluronic acid powder according to claim 1,
wherein the content of the hyaluronic acid particles having a particle diameter of less than or equal to 155 micrometers is 0 mass % to 55 mass % based on a total mass of the hyaluronic acid powder.

13. The hyaluronic acid powder according to claim 1,
wherein the content of the hyaluronic acid particles having a particle diameter of less than or equal to 190 micrometers is 0 mass % to 60 mass % based on a total mass of the hyaluronic acid powder.
